(19) United States
(12) Patent Application Publication
(10) Pub. No.: US 2005/0023174 A1
(43) Pub. Date: Feb. 3, 2005

(54) Plastic stackable container assembly

(76) Inventors: Banning Gray Lary, Miami, FL (US); Todd Pendleton Lary, Homestead, FL (US)

Correspondence Address: MCHALE & SLAVIN, P.A., 2855 PGA BLVD, PALM BEACH GARDENS, FL, 33410, US

(21) Appl. No.: 10/844,779

(22) Filed: May 12, 2004

Related U.S. Application Data
(60) Provisional application No. 60/469,692, filed on May 12, 2003.
(60) Provisional application No. 60/484,230, filed on Jun. 30, 2003.
(60) Provisional application No. 60/516,013, filed on Oct. 31, 2003.
(60) Provisional application No. 60/533,573, filed on Dec. 31, 2003.

(51) Int. Cl. B67B 7/00

(52) U.S. Cl. 206/509

(57) ABSTRACT

Disclosed is a thermoplastic, container for storage of solids, viscous or semi-viscous fluids that permit stacking one upon another for easy shipment and/or display. The container utilizes projections and recesses to engage similarly constructed containers for vertical stacking. Additionally, the container includes vertical ribs for enhanced strength. The removable caps used to seal the container include through holes to permit a rigid member to be passed through the length of the openings to apply the necessary torque to loosen the cap. The containers may be variably sized and can be reused.

### REFERENCE TO RELATED APPLICATIONS

This application claims benefit of the filing date of the following provisional patent applications: U.S. Patent Application No. 60/469,692, filed May 12, 2003; U.S. Patent Application No. 60/484,230 filed Jun. 30, 2003; U.S. Patent Application No. 60/516,013 filed Oct. 31, 2003; and U.S. Patent Application No. 60/533,573 filed Dec. 31, 2003.

### FIELD OF THE INVENTION

This invention is directed to blow molded type containers for storage of solids, viscous or semi-viscous fluids, such as paint, particularly to receptacles adapted to permit stacking one upon another for easy shipment and/or display and most particularly to containers reinforced with vertical ribs for enhanced the mechanical strength.

### BACKGROUND OF THE INVENTION

The classic paint can assembly has been in use for many years with little change in the composition or construction. Here the lid is often difficult to remove and requires special equipment or a screw driver and hammer. Screwdrivers often damage paint can lids and ruin the seal. Moreover, the lid is difficult to replace adequately without splattering the paint or other liquids, usually some strong force is necessary to secure the edges of the lid to the can and this can result in additional contamination of contained products. Reopening the lid another time can be extremely difficult.

The typical paint can wire handle is uncomfortable when carrying the usual gallon can filled with paint. Once used the apparatus has little further use and is discarded. Moreover, the cylindrical construction of the conventional paint receptacle permits them to roll off any surface and provides no means to allow them to stack vertically without falling.

The metallic material of the typical paint can allows for them to be easily bent and susceptible to rusting. The rust can then spread to the contents of the can, adjacent shelving, or even result in the subsequent leakage of the can's contents. The paint label can easily become difficult to read once obscured by paint or the label may contain false information as to the contents. Thereby the contents of the container can only be determined by removing the lid and stirring.

What is needed is a reusable container that is constructed from a durable, translucent/transparent, inert plastic material. Such a container could store most fluids and most any form of solid or semisolid substance. Additionally, substances in such a container would be easily identifiable without opening the container. A lid which provides secure, yet ready access to the contents would further increase usefulness. Moreover, space savings would increase if the containers could safely and securely be stacked one on top of another.

### PRIOR ART

Representative of prior art patents which disclose thermoplastic containers include U.S. Pat. No. 6,634,525, U.S. Pat. No. 6,530,500, U.S. Pat. No. 6,029,858, U.S. Pat. No. 5,823,345, U.S. Pat. No. 5,269,438, U.S. Pat. No. 4,805,793, U.S. Pat. Nos. 4,399,926, 4,014, 465 and U.S. Pat. No. 2,817,465.

### SUMMARY OF THE INVENTION

The current invention discloses a receptacle assembly that overcomes the above mentioned objections. The body of the container is formed from a transparent/translucent, high strength thermoplastic material with reinforcing struts for increased strength. Access to the fluids contained therein is via a large threaded cap that is positioned so as permit access to the contents through a large opening in the container. In one preferred embodiment, the screw on cap comprises a sleeve with a small opening through which an instrument, such as a cannon screw driver, can be passed to enable sufficient torque to be applied to screw or unscrew the cap onto the container. It is recommended that a non-adherent material be lightly applied to the threads of the screw apparatus after initially opening the container.

A comfortable handle is placed in the appropriate location approximately midway on the body of the container so that the vessel is easy to transport. In order that the containers can be stacked vertically, the cap, handle and/or projections on the upper surface of the container are arranged so as to cooperate with indentations formed on the bottom wall of a corresponding container to facilitate consistent, and stable stacking. In addition, pouring the container contents is facilitated by the formation of the indentation in the middle portion of the bottom of the container such that the user's fingers can be placed in a manner to stabilize and secure the pouring more accurately.

A primary objective of the instant invention, accordingly, is to provide a new and improved storage container adapted for reliable and compact stacking.

A further objective of the instant invention is to provide container closure means adapted for easy opening and closing.

An additional objective of the instant invention is provide a container wherein the contents are easily ascertained.

### BRIEF DESCRIPTION OF THE DRAWINGS

FIG. 1 is a perspective view of an assembled and closed receptacle which is formed in accordance with one embodiment of this invention;

FIG. 2 is a fragmented sectional frontal view of the second embodiment of the receptacle assembly perpendicular to the handle portion, wherein the cap is attached to the container body;

FIG. 3 is illustrating a top view of the second embodiment seen in FIG. 2;

FIG. 4 is a fragmented sectional side view of second embodiment in FIG. 2, parallel to the handle portion, wherein the cap is attached to the container body, FIG. 4 illustrates the location of the container opening proximate the front sidewall.

FIG. 5 is a fragmented sectional postural view of second embodiment in FIG. 2. of the receptacle assembly perpendicular to the handle portion, wherein the cap is attached to the container body.

FIG. 6 illustrates a bottom view of the second embodiment seen in FIG. 2;

FIG. 7 illustrates a top view of a third embodiment;

FIG. 8 is illustrates a bottom view of a third embodiment;

FIG. 9 is a fragmented sectional side view of third embodiment in FIGS. 7 and 8, parallel to the handle portion, wherein the cap is attached to the container body;

FIG. 10 is top view of a plurality of the third embodiment showing containers vertically stacked.

### DETAILED DESCRIPTION OF THE INVENTION

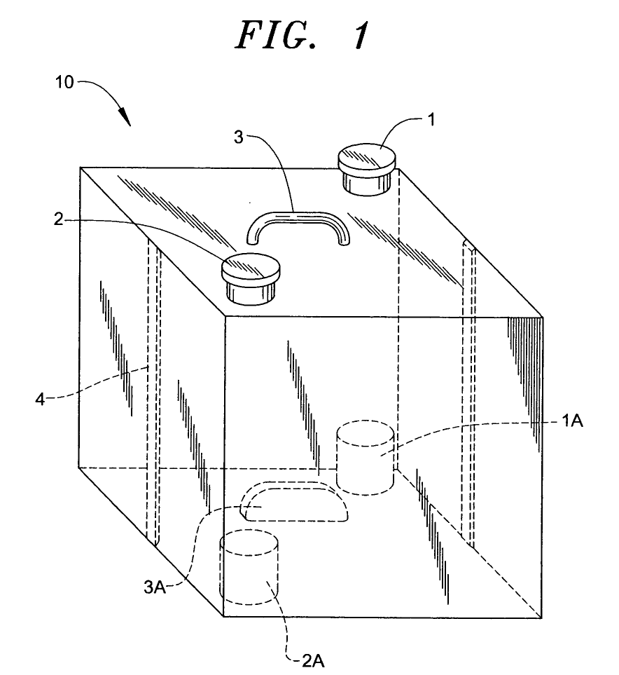

All of the various embodiments of the container assemblies are comprised of a blow molded thermoplastic that is at least semi-transparent. The container assemblies are generally shaped as an empty cube with rounded edges, or as a hollow rectangular box. The containers can be made in various sizes, including pint, ¾ pint, or gallon sizes. Referring now to the drawings, the first embodiment of the receptacle assembly is shown in FIG. 1. The container assembly 10 is shown having continuous sidewalls, a bottom and upper surface both integral with the sidewalls. On the upper surface and proximate to opposite corners are elevated threaded pouring spouts 1 and 2. These spouts 1 and 2 provide access to the interior of the container and are fitted with plastic screw caps of conventional design (not shown). The diameter of spouts 1, 2 can be varied to serve specific purposes.

Between these two spouts 1 and 2 is placed an integrally formed handle 3 that is generally longitudinally located in a perpendicular direction to the line between the midpoints of the spouts 1 and 2. The handle 3 should be located at the balance point for ease of transporting and of sufficient size to admit the human hand. The bottom surface of the container has recesses, or indentions, 1A and 2A formed therein that accommodate the insertions of the spouts 1 and 2 and an indentation 3A that accommodates the handle 3 of a bottom container of similar construction, when the containers are stacked vertically.

Throughout the general construction of the container sidewalls various stress areas are reinforced with a plurality of vertically oriented plastic material, e.g. ribs or struts, 4 which enhance the strength of the receptacle body such that the containers can be stacked or dropped on a hard surface without rupturing. The ribs 4 can be made such that the additional material are formed externally or internally.

The filling of the container 10 of the first embodiment with liquid is accomplished through either or both of the spouts 1 and 2. The placement of the spouts 1 and 2 proximate opposite corners of the receptacle 10 permit a variety of filling and pouring methods with a minimal of spillage onto the upper surface or container body 14. Preferably, at least one of the spouts is large enough to permit mixing and an access for brushes or cleaning materials inside the container. By holding the handle 3 and placing the other hand on the bottom opposite to the active spout, a controlled and spillage free transfer of the contents can be achieved.

The screw caps on the spouts, or the elevated spouts 1 and 2, may be treated with a non-adherent material, for example VASELINE or silicone grease. This will ensure the caps are sealed as well, prevent adherence of the fluid contents to the spout, facilitate pouring into another container and make cap removal easier. When stacking a plurality of container assemblies 10 one simply places the superior apparatus external spouts indentions 1A and 2A and handle indention 3A onto the corresponding spouts projections 1, 2 and handle 3 on the upper surface of a geometrically similar receptacle assembly underneath. In this manner a number of containers can be stored vertically and side by side with a great saving in space. Identification labels, instructions, and other indicia is legible on any outwardly facing side.

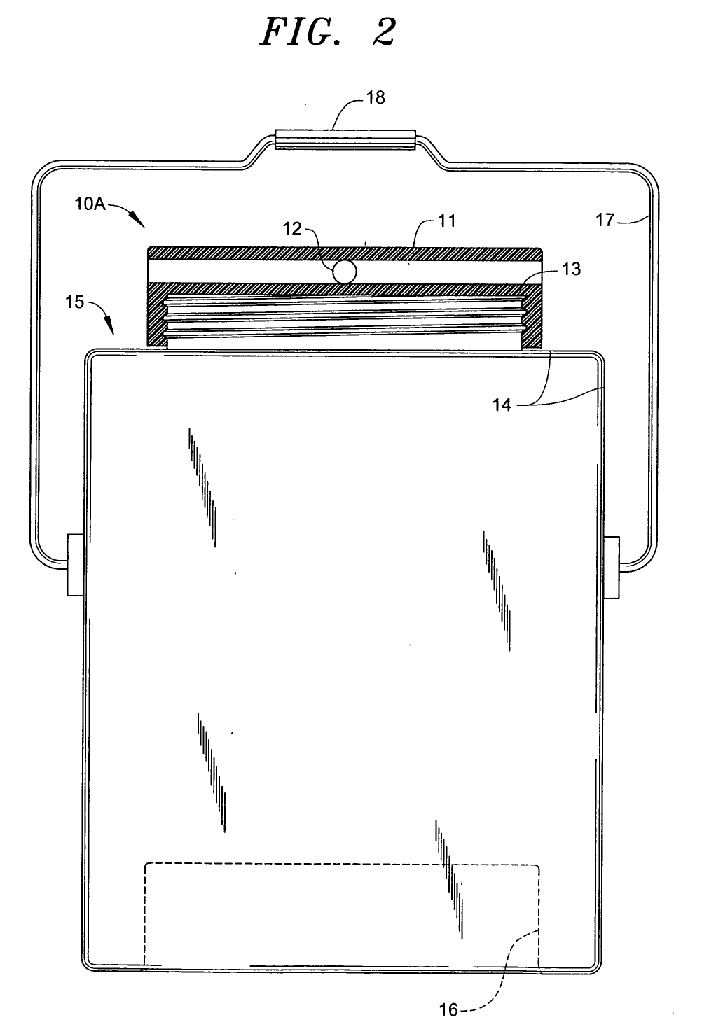

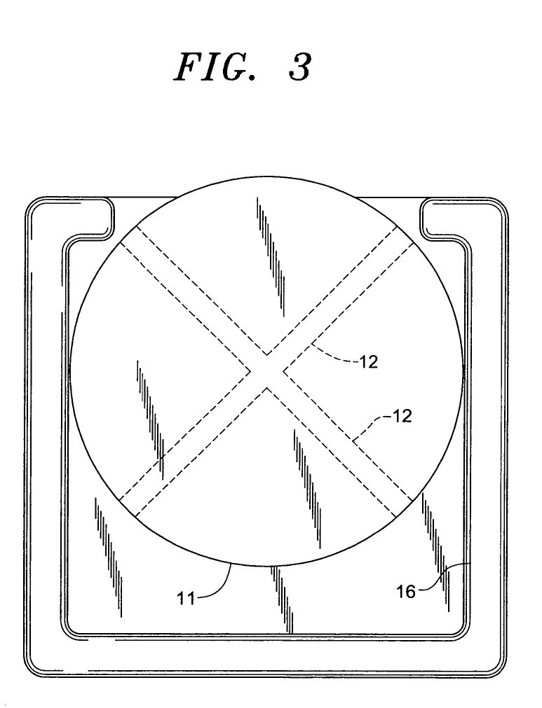

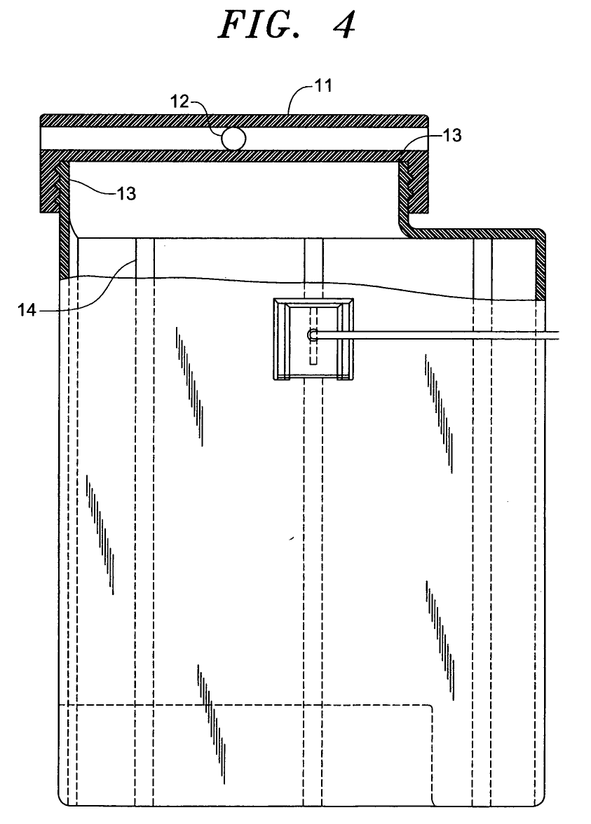

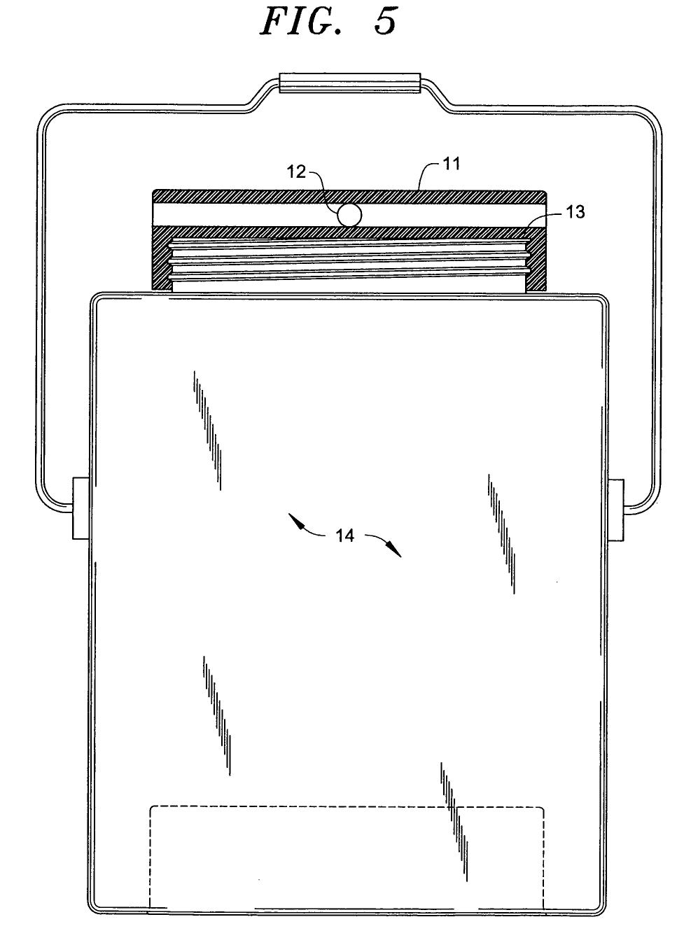

Referring now to the second embodiment of the receptacle assembly 10 as shown in FIGS. 2 to 6, the assembly 10 is illustrated as a rectangular structure consisting of clear thermoplastic material. It contains a hollow body 14 that has an elevated threaded opening 13 to which is attached a removable cap 11. The opening 13 should have a diameter large enough to permit access to a four inch paint brush or a large human hand. The diameter of the opening 13 should also be of such a diameter as to permit pouring of the contents without the necessity of an air intake vent. As shown from top view in FIG. 3, and sideview of FIG. 4, the cap 11 extends a short distance from the front sidewall edge of the body 14 of the apparatus 10. This feature permits the pouring edge of the threaded extension, or opening, 13 to be in direct alignment with the body 14. The location of the pouring edge of the opening 13 along the front sidewall permits the pouring of the container 10 contents with a minimal amount of spillage onto the container body 14.

As illustrated in FIG. 3, through the body of the cap 11 are formed at least two openings 12, or sleeves, that extend the entire length of the cap 11. These openings are perpendicular to one another. These cap openings 12 permit a rigid tubular member (not shown), such as a screwdriver to be inserted within the openings to apply the necessary torque to loosen the cap 11 should the cap 11 become strongly adherent to the body 14 of the container due to thermal expansion, dried paint or other contaminates.

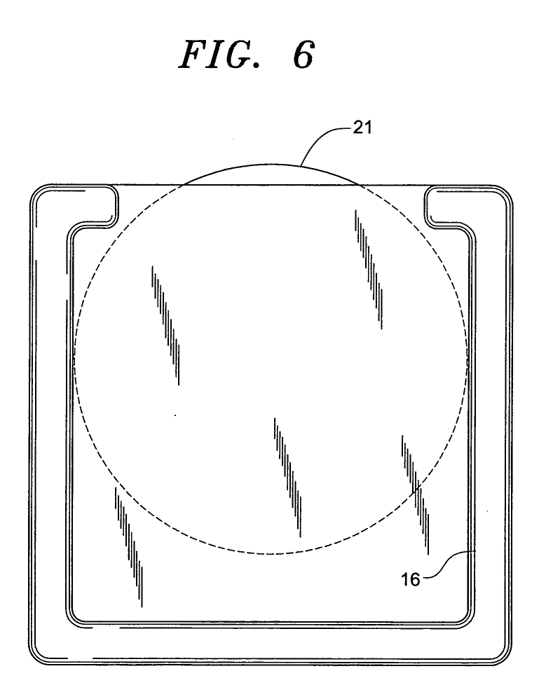

As seen from the bottom view of the container assembly, FIG. 6, longitudinal extensions 16 of the body 14 are integrally formed, or separately adhered, to the bottom surface of the container and about the inferior periphery of the body 14. The peripheral extensions 16 do not extend completely across the front, bottom surface such that a space 21 is left for the cap 11 of a lower container to extend outside the encirclement for a distance of the depth of the wall of the cap, when a plurality of container assemblies are stacked vertically. This feature permits the entire stacking procedure to occur without increasing the volume of the container.

FIG. 2 shows the longitudinal depressions, or recesses, 15 are similarly formed about the superior periphery of the body 14. When vertically stacking the container assemblies 10, the longitudinal extensions 16 on the bottom surface of the upper container engages the longitudinal depressions 15 of the lower container to laterally locate and stabilize the relative positions of the two containers. Additionally, the longitudinal extensions 16 can be used to facilitate gripping the container with one hand while pouring the contents from the container.

A corrosion-resistant metal swing handle 17 is attached to the sidewalls of the container body 14 similar to the construction of the conventional paint can known in the art. A soft plastic material 18 encircles the middle of the handle 17. The soft plastic material 18 allows for comfortable handling of the filled container such that the handle does not create discomfort through direct contact with the user's hand.

As seen in the first embodiment, the second embodiment can comprise numerous reinforcing struts 4 for increased strength of the container. These struts can be formed externally or internally on the sidewall, and are located for maximal strength.

When pouring a liquid from the container of the second embodiment, the swing handle 17 is held with one hand and the fingers of the other hand are placed on the longitudinal extension 16 of the bottom surface of the body 14, on the side opposite to the threaded extension 13. This permits increased control of the pouring action and also helps to prevent spillage. The cap 11 extends a short distance on one edge from the body 14 of the container 10. This feature permits the pouring edge of the threaded extension 13 to be in direct alignment with body 14.

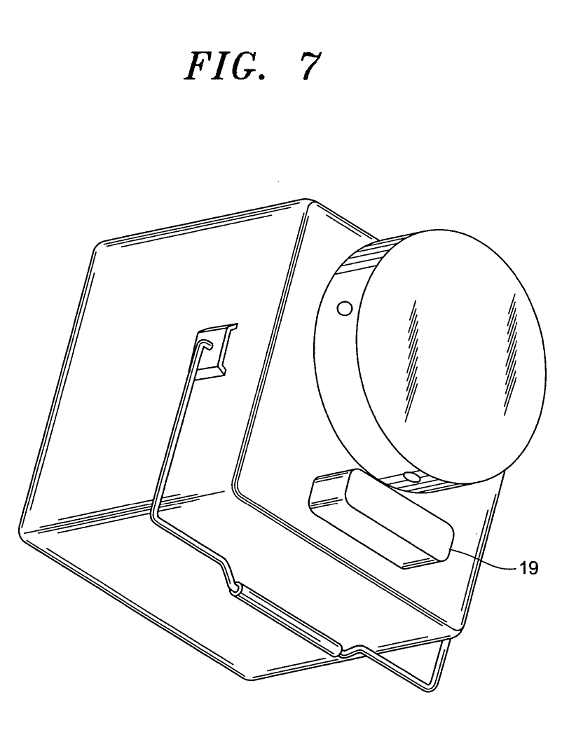

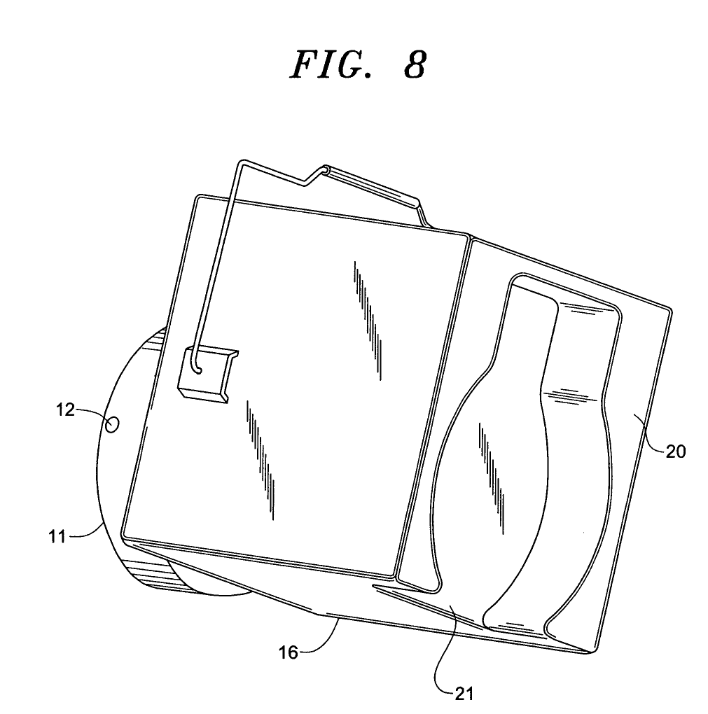

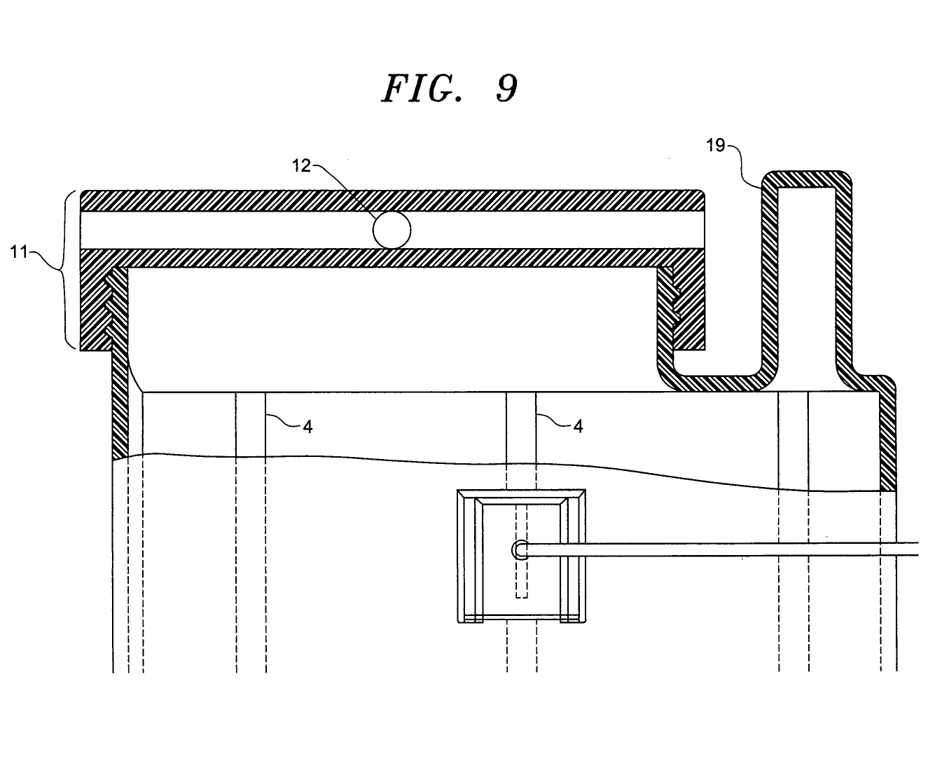

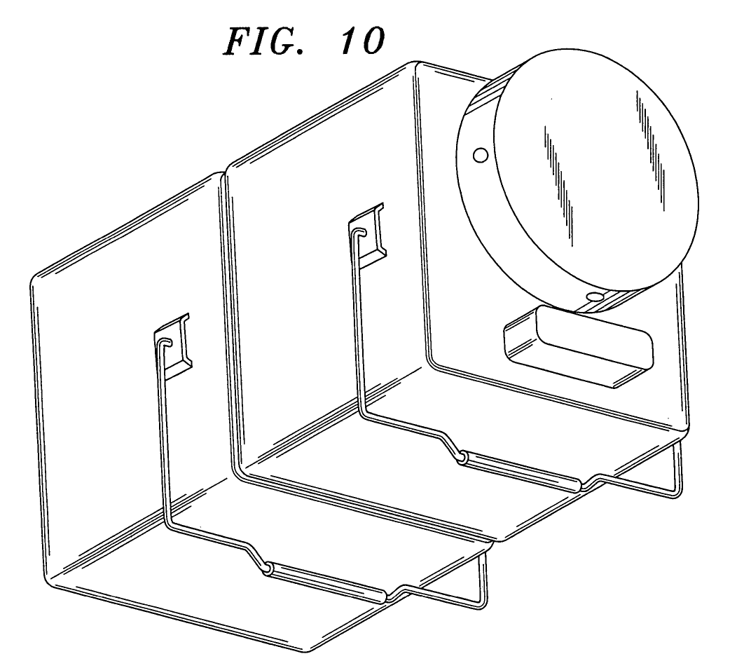

The third embodiment seen in FIGS. 7-10, is substantially the same construction as that seen in the second embodiment with the addition of a rectangular protrusion 19, which is formed integrally, or separately adhered, to the top surface of the container body 14. This protrusion 19 should be of a size such that it will fit between the elongated extensions of geometrically similar containers, thereby providing additional stability when vertically stacked. The protrusion 19 height can be lower, even with, or higher than the top surface of the elevated threaded opening 13. In a preferred embodiment, the protrusion 19 is higher than that of the opening 13 such that a paint brush can be rested thereon. The bottom view of the third embodiment, seen in FIG. 8, clearly shows the area 20 on the longitudinal extensions 16 which can be used to facilitate gripping the bottom of the container when pouring the contents from the container.

The basic design of the above embodiments permit almost any volume to be achieved and the gallon is merely representative of a most common volume. As illustrated, the volume of the container closely approximates that of a standard gallon of fluid. Such standard gallon represents 231 cubic inches and the volume of the instant container as demonstrated is 237 cubic inches. If necessary, small variations in dimensions of the container can more exactly approximate that of the true gallon.

The container assembly of all the above mentioned embodiments have the potential to be used repeatedly with the same or other liquids. While it may be used for the storage of liquids initially, at another time it could be used for the storage of most any other material. This feature can make for great savings of materials and money.

One skilled in the art will readily appreciate that the present invention is well adapted to carry out the objects and obtain the ends and advantages mentioned, as well as those inherent therein. Any compounds, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A stackable container assembly for holding a substance, said assembly comprising:
a container body having continuous sidewalls, a bottom wall and an upper wall each being both integral with said sidewalls;
said bottom wall including at least three recesses;
said upper surface including at least two projecting, threaded pouring spouts and a handle portion;
at least two caps constructed and arranged to sealing engage said pouring spouts;
wherein the at least two of said recesses are adapted to receive said elevated, threaded pouring spouts and said third recess is adapted to receive a raised handle of a second container assembly;
wherein stable, vertical stacking of plural containers is achieved.

2. The assembly of claim 1, wherein the projecting pouring spouts are located proximate opposite corners of said assembly whereby spillage onto the upper wall or container body is minimized.

3. The assembly of claim 1, wherein at least one of said spouts are of a size to allow for access by a paintbrush or stirring means.

4. The assembly of claim 1, wherein said caps are treated with a non-adherent material to facilitate opening thereof.

5. The assembly of claim 1, further comprising a plurality of vertically spaced lugs along the sidewalls of said container body.

6. The assembly of claim 1, wherein said container is transparent.

7. The assembly of claim 1, wherein said caps comprise a plurality of openings to allow for access by a screwdriver, or other rigid means, to facilitate opening thereof.

8. A stackable container assembly for holding a substance, said assembly comprising:
a container body having continuous sidewalls, a bottom wall and an upper wall each being integral with said sidewalls;
said bottom wall including at least one projection;
said upper wall including an elevated threaded opening and at least one recess;
a cap constructed and arranged to sealing engage said elevated threaded opening;
wherein said at least one recess is adapted to receive said at least one projection of a second container assembly;
wherein stable, vertical stacking of plural containers is achieved.

9. The assembly of claim 8, wherein said elevated threaded opening includes a pouring edge which is in direct alignment with said sidewall.

10. The assembly of claim 8, wherein said at least one projection partially extends across a front portion of said bottom wall whereby a space is left for a cap of a lower container to extend therein when a plurality of container assemblies are stacked vertically.

11. The assembly of claim 8, further comprising a plurality of vertically spaced lugs along the sidewalls of said container body.

12. The receptacle assembly of claim 8, further comprising a corrosion-resistant metal swing handle attached to said sidewalls of said container;
wherein a soft plastic material encircles the middle of the handle.

13. The assembly of claim 8, wherein said container is transparent.

14. The assembly of claim 8, wherein said cap contains a plurality of openings to allow for access by a rigid means to facilitate opening thereof.

15. A stackable container assembly for holding a substance, said assembly comprising:
a container body having continuous sidewalls, a bottom wall and upper wall each being integral with said sidewalls;
said bottom wall including at least one projection;
said upper surface including an elevated threaded opening and at least one recess and an elevated projection;
a cap constructed and arranged to sealing engage said elevated threaded opening;
wherein said at least one recess is adapted to receive said at least one projection of a second container assembly;
wherein stable, vertical stacking of plural containers is achieved.

16. The assembly of claim 15, wherein said elevated threaded opening includes a pouring edge which is in direct alignment with said sidewall.

17. The assembly of claim 15, wherein said at least one projection partially extends across a front portion of said bottom wall whereby a space is left for a cap of a lower container to extend therein when a plurality of container assemblies are stacked vertically.

18. The assembly of claim 15, further comprising a plurality of vertically spaced lugs along the sidewalls of said container body.

19. The receptacle assembly of claim 15, further comprising a corrosion-resistant metal swing handle attached to said sidewalls of said container;
wherein a soft plastic material encircles the middle of the handle.

20. The assembly of claim 15, wherein said container is transparent.

21. The assembly of claim 15, wherein said cap contains a plurality of openings to allow for access by a rigid means to facilitate opening thereof.
